(19) United States
(12) Patent Application Publication
(10) Pub. No.: US 2016/0033678 A1
(43) Pub. Date: Feb. 4, 2016

(54) MOBILE DEVICE WITH WEATHER FORECAST

(71) Applicant: HTC Corporation, Taoyuan City (TW)

(72) Inventor: Yu-Cheng LEE, Taoyuan City (TW)

(73) Assignee: HTC Corporation, Taoyuan City (TW)

(21) Appl. No.: 14/541,745

(22) Filed: Nov. 14, 2014

Related U.S. Application Data
(60) Provisional application No. 62/031,861, filed on Aug. 1, 2014.

(51) Int. Cl. G01W 1/10

(52) U.S. Cl. CPC G01W 1/10

(57) ABSTRACT

A computer-implemented method includes obtaining, from a storage unit of a mobile device, an event that includes an event start time and an event occurring location; obtaining, by the mobile device, first weather information that is related to the event start time at the event occurring location from a weather server; determining, by the mobile device, whether a forecasted weather condition of the event is unsuitable for the event at the event occurring location based on the first weather information; obtaining second weather information that is related to the event start time at a candidate location from the weather server based on a determination that the forecasted weather condition of the event is unsuitable for the event; and providing, by the mobile device, a recommended location based on the second weather information.

### CROSS-REFERENCE TO RELATED APPLICATIONS

This application claims the benefit of priority under 35 U.S.C. §119(e) on U.S. Provisional Patent Application No. 62/031,861 filed on Aug. 1, 2014, the entirety of which is incorporated herein by reference.

### BACKGROUND OF THE INVENTION

1. Field of the Invention

The disclosure relates in general to a mobile device, and more particularly, to a mobile device with weather forecast.

2. Background of the Invention

Nowadays, the mobile device is usually with the ability of providing the weather information. Users can know the weather status from the mobile device thereof. Specifically, the mobile device can know where the user is located and provide the current weather status based the user location. Furthermore, the mobile device provides the current weather status based the location assigned by the users.

For example, the users have an event at the location A, but know that it is raining at the location A from the mobile device. The users can check the weather status of the location B from the mobile device immediately and determine whether the location B is suitable for the event or not. However, the users need to check and determine whether the weather of other location is suitable for the event or not by themselves. It is not convenient for the users.

### SUMMARY OF THE INVENTION

Accordingly, it is highly desirable to provide a mobile device with weather forecast that allows users to properly get or select a suitable location for the event.

One objective of the present invention is to provide a computer-implemented method, which comprises obtaining, from a storage unit of a mobile device, an event that includes an event start time and an event occurring location; obtaining, by the mobile device, first weather information that is related to the event start time at the event occurring location from a weather server; determining, by the mobile device, whether a forecasted weather condition of the event is unsuitable for the event at the event occurring location based on the first weather information; obtaining second weather information that is related to the event start time at a candidate location from the weather server based on a determination that the forecasted weather condition of the event is unsuitable for the event; and providing, by the mobile device, a recommended location based on the second weather information.

Another objective of the present invention is to provide a mobile device working with a weather server which comprises a communicating unit, a storage unit, and a control unit. The communicating unit is configured to connect with the weather server. The storage unit is configured to store an event including an event start time and an event occurring location. The control unit is coupled to the storage unit and the communicating unit, and is configured to: obtain, from a storage Unit of a mobile device, the event; obtain, via the communicating unit, first weather information that is related to the event start time and the event occurring location from a weather server; determine whether a forecasted weather condition of the event is unsuitable for the event based on the first weather information; obtain, via the communicating unit, second weather information that is related to the event start time and a candidate location from the weather server based on a determination that the forecasted weather condition of the event is unsuitable for the event by the mobile device; and provide a recommended location based on the second weather information by the mobile device.

Further scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The present invention will become more fully understood from the detailed description given hereinbelow and the accompanying drawings which are given by way of illustration only, and thus are not limitative of the present invention, and wherein:

FIG. 1 is a block diagram of a forecasted weather system of the embodiment according to an embodiment of the present invention; and

FIG. 2 is a block diagram of a mobile device and the forecasted weather system of the embodiment according to an embodiment of the present invention.

### DETAILED DESCRIPTION OF THE ILLUSTRATED EMBODIMENTS

The present invention will now be described in detail with reference to the accompanying drawings, wherein the same reference numerals will be used to identify the same or similar elements throughout the several views. It should be noted that the drawings should be viewed in the direction of orientation of the reference numerals.

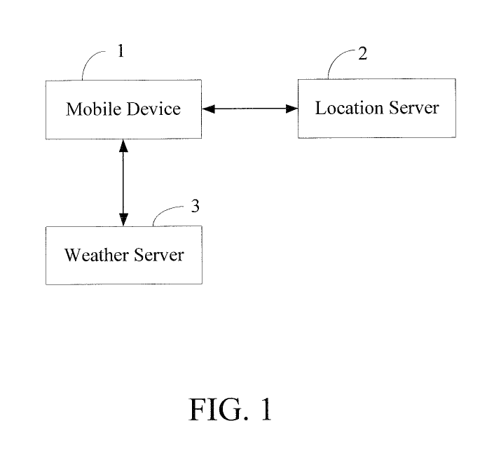

Referring to FIG. 1, a block diagram of a forecasted weather system is shown according to an embodiment of the present invention. The forecasted weather system includes a mobile device 1, a location server 2, and a weather server 3. In an embodiment, the location server 2 can be a LBS (Location Base server). The location server 2 can provide the location information corresponding to the location of the mobile device 1. The weather server 3 can provide the weather information to the mobile device 1 based on the location information of the mobile device 1. The mobile device 1 can provide the user with some useful comment/information based on where the user wants to go, what the user wants to do, and the weather information.

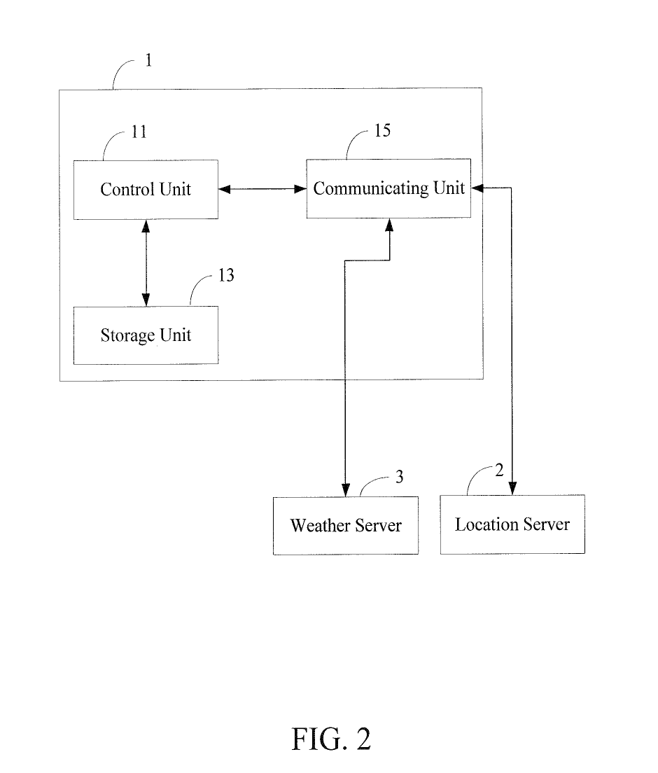

FIG. 2 illustrates a block diagram of the mobile device 1 in accordance with an embodiment of the present invention. The mobile device 1 comprises a control unit 11, a storage unit 13, and a communicating unit 15. The control unit 11 is coupled to the storage unit 13 and the communicating unit 15. For example, the control unit 11 may be a MCU (Microcontroller Unit), a CPU (Central Processing Unit), or any hardware that is configured to perform the operations as described here in blow. The communicating unit 15 can communicate with a wireless router, a mobile phone, or a wireless base station. For example, the communicating unit 15 can include at least one of Wi-Fi module, LTE module, Bluetooth module, GSM module (2G/3G/4G), the module conforming to any communication standard/specification, and the combination thereof. The storage unit 13 is configured to store some information about the user or the mobile device 1. In one embodiment, the information stored in the storage unit 13 comprises some events such as calendar events. For illustration purposes only, the calendar events are taken as an example below.

In particular, the storage unit 13 of the mobile device 1 stores the calendar events. The control unit 11 obtains a calendar event from the storage unit 13 and analyzes the calendar event to determine the event start/end time, the event occurring location, the event type, outdoor or indoor etc. For example, if the calendar event indicates that the user schedules to play basketball at the basketball court A on Jan. 1, 2015 at 3 pm, the control unit 11 can analyze the calendar event to determine the event start time (Jan. 1, 2015 at 3 pm), the event occurring location is outdoor or not (basketball court A) and the event type (basketball).

In this illustrated embodiment, after the control unit 11 obtains the event start time and the event occurring location, the control unit 11 can query first weather information from the weather server 3 via the communicating unit 15 based on the event start time and the event occurring location. The first weather information comprises the weather forecast at the event occurring location around the event start time. For example, the first weather information may indicate that it will rain at basketball court A on Jan. 1, 2015 from 2 pm to 4 pm.

The control unit 11 determines whether a forecasted weather condition of the calendar event is unsuitable for the calendar event at the event occurring location based on the first weather information. If the forecasted weather condition of the calendar event is unsuitable for the calendar event, the control unit 11 will obtain second weather information that is related to the event start time and one or more candidate locations from the weather server 3. If the forecasted weather condition of the calendar event is suitable for the calendar event, no further action is necessary by the control unit 11.

For example, the user schedules to play basketball at the basketball court A on Jan. 1, 2015 at 3 pm. If the first weather information indicates that it will rain at basketball court A on Jan. 1, 2015 from 2 pm to 4 pm, the control unit 11 determines that it is unsuitable for playing basketball at basketball court A. Then the control unit 11 will obtain second weather information that is related to the event start time and one or more candidate locations from the weather server 3. If the first weather information indicates that it will be sunny at basketball court A all day on Jan. 1, 2015, the control unit 11 determines that it is suitable for playing the basketball and takes no further action.

In one embodiment, the first weather information includes weather information at the event occurring location between a time before the event start time and the event start time. For example, if the user schedules to play basketball at the basketball court A on Jan. 1, 2015 at 3 pm, the first weather information may comprise the weather information at the event occurring location from 1 pm to 3 pm. In one embodiment, the first weather information may include a rain end time that is before and closest to the event start time. For example, if the event start time is 3 pm and the rain stops at 2 pm, then its rain end time is 2 pm. If the rain starts again and then stop at 2:30 pm, the rain end time will be updated to 2:30 pm.

Accordingly, if the first weather information includes a rain end time that is before and closest to the event start time. In one embodiment, the control unit 11 will decide/set a threshold time period based on the event type. Then the forecasted weather condition of the calendar event is determined to be unsuitable for the calendar event based on a determination that a no-rain time period between the rain end time and the event start time is shorter than a threshold time period by the control unit 11.

In one embodiment, the event type can be the activity the user plans to do, such as playing basketball, running, play golf, and so on. Firstly, the control unit 11 will set/decide the threshold time period based on the event type. For example, the people often play soccer on the grasslands, and play basketball on the court with PU material. If there is rain on the grasslands and the court with PU material, they need different time periods to become dry for making the exercise safe.

In general, the grasslands need more time to become dry than the court with PU material. In one embodiment, the control unit 11 sets/selects a longer threshold time period, e.g., 2 hours, for the grasslands, and sets/selects a shorter threshold time period, e.g., 1 hour, for the court with PU material. If the no-rain time period corresponding to the soccer is shorter than 2 hours, the control unit 11 determines that the forecasted weather condition of the calendar event is unsuitable for soccer. If the no-rain time period corresponding to the basketball is shorter than 1 hour, the control unit 11 determines that the forecasted weather condition of the calendar event is unsuitable for basketball.

In one embodiment, the control unit 11 may obtain one or more candidate locations based on the event type. For example, different sports events are suitable at different places. Soccer is suitable for grasslands, and basketball is suitable for the court with PU material. For example, there are basketball courts A, B, C and soccer fields D, E, F that be may available as candidate locations. If the event type shows the user will play basketball, the basketball courts A, B, C are selected as the candidate locations by the control unit 11, and the soccer fields D, E, F are not selected.

If the forecasted weather condition of the calendar event is determined to be unsuitable for the calendar event based on the first weather information, the control unit 11 will further obtain second weather information that is related to the event start time at one or more candidate locations from the weather server 3. Then the control unit 11 recommends an alternative location for the event by selecting one of the one or more candidate locations as the alternative location based on the second weather information.

For example, the calendar event shows that the user schedules to play basketball at the basketball court A on Jan. 1, 2015 3 pm. If the first weather information shows that the weather at basketball court A around 3 pm is unsuitable for playing basketball, the control unit 11 will further obtain the weather information about one or more candidate locations stored in the storage unit 13 around 3 pm.

In one embodiment, same as the first weather information, the second weather information comprises weather information during a time period between a time before the event start time and the event start time related to all candidate location(s), and a rain end time that is before and closest to the event start time and related to all candidate locations.

In one embodiment, the mobile device 1 has the ability to record the user behavior in the storage unit 13. In one embodiment, the user behavior comprises the candidate location(s) the user did exercise ever, the usage frequency of the candidate location(s) the user did exercise ever, the geographical place of the candidate location(s) the user did exercise ever, etc.

For example, the user may have played basketball at different basketball courts A, B, and C, and the storage unit 13 records these courts as the candidate locations. If the user went to the court A three times, the court B twice and the court C once in the last month, the storage unit 13 records these as the usage frequency of the candidate locations. The storage unit 13 also records the geographical information about the basketball courts A, B, and C.

Firstly, the control unit 11 determines whether the forecasted weather condition of each of the one or more candidate locations is unsuitable for the calendar event based on the second weather information. Then the control unit 11 selects one from one or more candidate locations suitable for the calendar event and/or event type.

For example, the control unit 11 determines that the court A is unsuitable for playing basketball based on the first weather information. Then the control unit 11 selects the courts suitable for playing basketball. If the weather around the courts B and C is sunny all day on Jan. 1, 2015, the control unit 11 selects the courts B and C as the candidate locations.

If only one candidate location is selected out, the control unit 11 provides the candidate location as the recommended location. If more than one candidate locations are available, the control unit 11 may perform the further selecting process to select a recommended location from the candidate locations selected by the control unit 11.

The control unit 11 can obtain the current location of the mobile device 1 from the GPS thereof or the location server 2. In one embodiment, the current location of the mobile device 1 is considered as a departure point/location against each of the candidate locations selected by the control unit 11. The control unit 11 can calculate the transportation time between the departure point/location and each of the candidate locations. The control unit 11 also calculates a time difference between the current time and the event start time and determines whether any of transportation time of each candidate location is smaller than the time difference between the current time and the event start time. The control unit 11 selects the candidate location with the shortest transportation time as the recommended alternative location, wherein the shortest transportation time is smaller than the time difference between the current time and the event start time as well.

For example, it is assumed that the current time is Jan. 1, 2015 at 1 pm and the event start time is Jan. 1, 2015 at 3 pm. In other words, the time difference between the current time and the event start time is 2 hours. The transportation time between the departure point/location and the court B is 2.5 hours. The transportation time between the departure point/location and the court C is 1.5 hours. The control unit 11 selects the court C as the recommended alternative location because the court C is with the shortest transportation time (1.5 hours) that is smaller than the time difference between the current time and the event start time (2 hours).

In another embodiment, the control unit 11 can calculate the distance between the departure point/location and each candidate location, and select the candidate location with the shortest distance as the recommended alternative location. For example, it is assumed that the distance between the court B and the departure point/location is 15 KM, and the distance between the court C and the departure point/location is 5 KM. The control unit 11 selects the court C as the recommended alternative location.

In addition, the storage unit 13 stores the usage frequency of the candidate location the user did exercise ever, so the control unit 11 select the candidate location, which the user go most often, as the recommended alternative location. For example, like the courts B, and C described in the above paragraphs, the user went to the court B twice and the court C once in last month. The control unit 11 selects the court B as the recommended alternative location due to its higher usage frequency.

Moreover, the control unit 11 may select the recommended alternative location from the candidate locations based on a weight rule. The weight rule comprises one or more of the following parameters:
1. Frequency of visiting this candidate location (the higher the better)
2. Distance to this candidate location (the closer the better)
3. Historic duration of stay at this candidate location (the longer the better)
4. Match event type (optional, for example, if it is known that the user is going to play basketball, only list the basketball court(s) from historic data)
5. The weather condition of recommended place(s) (for example, windy is not good for Golfing but good for surfing).

The invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

What is claimed is:

1. A computer-implemented method comprising:
obtaining, from a storage unit of a mobile device, an event that includes an event start time and an event occurring location;
obtaining, by the mobile device, first weather information that is related to the event start time at the event occurring location from a weather server;
determining, by the mobile device, whether a forecasted weather condition of the event is unsuitable for the event at the event occurring location based on the first weather information;
obtaining second weather information that is related to the event start time at one or more candidate locations from the weather server based on a determination that the forecasted weather condition of the event is unsuitable for the event; and
recommending an alternative location for the event by selecting one of the one or more candidate locations as the alternative location based on the second weather information.

2. The method of claim 1, wherein the first weather information includes weather information at the event occurring location during a time period between a time before the event start time and the event start time.

3. The method of claim 2, wherein the first weather information includes a rain end time that is before and closest to the event start time.

4. The method of claim 3, wherein the forecasted weather condition of the event is determined to be unsuitable for the event based on a determination that a no-rain time period between the rain end time and the event start time is shorter than a threshold time period.

5. The method of claim 4, wherein the event further includes an event type, the method further comprising:
setting the threshold time period based on the event type.

6. The method of claim 1, wherein the second weather information includes weather information during a time period between a time before the event start time and the event start time at the one or more candidate locations.

7. The method of claim 6, wherein the first weather information includes a rain end time that is before and closest to the event start time.

8. The method of claim 1, wherein the one of the one or more candidate locations is selected as the alternative location further based on a transportation time period from a departure location to the one or more candidate locations.

9. The method of claim 8, wherein the step of recommending the alternative location based on the second whether information and the transportation time period includes:
determining whether the transportation time period for each of the one or more candidate locations is smaller than a time difference between a current time and the event start time; and
selecting one of the one or more candidate locations that has the transportation time period smaller than the time difference between the current time and the event start time based on the second weather information.

10. The method of claim 1, wherein the one of the one or more candidate locations is selected as the alternative location further based on a distance from a departure location to the one or more candidate locations.

11. The method of claim 1, wherein the one of the one or more candidate locations is selected as the alternative location further based on the number of times that the user has been to each of the one or more candidate locations.

12. The method of claim 1, wherein the event further includes an event type, the method further comprising:
obtaining the one or more candidate locations based on the event type.

13. A mobile device working with a weather server, the mobile device comprising:
a communicating unit, being configured to connect with the weather server;
a storage unit, being configured to store an event including an event start time and an event occurring location; and
a control unit, being coupled to the storage unit and the communicating unit, and being configured to:
obtain, from the storage unit, the event;
obtain, via the communicating unit, first weather information that is related to the event start time at the event occurring location from a weather server;
determine whether a forecasted weather condition of the event is unsuitable for the event based on the first weather information;
obtain, via the communicating unit, second weather information that is related to the event start time at one or more candidate locations from the weather server based on a determination that the forecasted weather condition of the event is unsuitable for the event; and
recommend an alternative location for the event by selecting one of the one or more candidate locations as the alternative location based on the second weather information.

14. The mobile device of claim 13, wherein the first weather information includes weather information at the event occurring location during a time period between a time before the event start time and the event start time.

15. The mobile device of claim 14, wherein the first weather information includes a rain end time that is before and closest to the event start time.

16. The mobile device of claim 15, wherein the control unit determines that the forecasted weather condition of the event is unsuitable for the event based on a determination that a no-rain time period between the rain end time and the event start time is shorter than a threshold time period.

17. The mobile device of claim 16, wherein the event further includes an event type, and the control unit sets the threshold time period based on the event type.

18. The mobile device of claim 13, wherein the second weather information includes weather information during a time period between a time before the event start time and the event start time at the one or more candidate locations.

19. The mobile device of claim 18, wherein the first weather information includes a rain end time that is before and closest to the event start time.

20. The mobile device of claim 13, wherein the control unit is further configured to select the one of the one or more candidate locations as the alternative location further based on a transportation time period from a departure location to the one or more candidate locations.

21. The mobile device of claim 20, the control unit is configured to:
determine whether the transportation time period for each of the one or more candidate locations is smaller than a time difference between a current time and the event start time; and
select one of the one or more candidate locations that has the transportation time period smaller than the time difference between the current time and the event start time based on the second weather information.
